(19) United States
(12) Patent Application Publication
(10) Pub. No.: US 2014/0227552 A1
(43) Pub. Date: Aug. 14, 2014

(54) THERMAL INSULATION STRUCTURE

(71) Applicants: Albert Pui Sang Lau, Kowloon (HK); Lee Cheung Lau, Kowloon (HK); Manas Kumar Sarkar, Kwai Chung (HK); Jintu Fan, Shatin (HK)

(72) Inventors: Albert Pui Sang Lau, Kowloon (HK); Lee Cheung Lau, Kowloon (HK); Manas Kumar Sarkar, Kwai Chung (HK); Jintu Fan, Shatin (HK)

(73) Assignee: SK PLANET CO., LTD, Seongnam-si, Gyeonggi-do (KR)

(21) Appl. No.: 14/342,352

(22) PCT Filed: Aug. 31, 2012
(86) PCT No.: PCT/IB2012/001678

§ 371 Date: Apr. 28, 2014

(30) Foreign Application Priority Data
Sep. 1, 2011 (CN) 201120324889.0

(51) Int. Cl. F16L 59/02

(52) U.S. Cl. CPC F16L 59/029
USPC 428/621; 428/35.2; 428/35.3; 428/221; 442/67; 442/218; 442/230; 442/231; 442/238; 442/316; 442/379; 442/400

(57) ABSTRACT

A thermal insulation structure including a fabric layer and a dual-layer infrared radiation reflective metal coating disposed on a surface of the fabric layer. The dual-layer infrared radiation reflective metal coating includes a first coating layer directly applied on to the surface of the fabric layer, and, a second coating layer applied on to the first coating layer.

### TECHNICAL FIELD

The present invention relates to a thermal insulation structure, more particularly, to a thermal insulation structure capable of blocking thermal radiation whilst alleviating obstruction of moisture vapor transmission.

### BACKGROUND OF THE INVENTION

Thermal insulation and cold-proof materials are applied in various applications such as in building structures, energy storage facilities, aircrafts, and cold-proof clothing for reducing thermal transmission between media and their surroundings. Compared with various other thermal insulation and cold-proof materials, such as powder thermal insulation materials, foam thermal insulation materials, and vacuum panel materials, fibrous thermal insulation materials have advantages such as desirable thermal insulation, light weight, good moisture absorption and vapor transmission, and high shock absorption capacity, because of a very high porosity, generally equal to or greater than 95% (Tseng and Kuo, Thermal radiative properties of phenolic foam insulation, Journal of Quantitative spectroscopy & Radiative Transfer, 72, 349-359 (2002). In fibrous thermal insulation materials, a thermal transmission mechanism mainly involves thermal conduction and thermal radiation (Farnworth, Mechanisms of heat flow through clothing insulation, Textile Research Journal, 53(12), 717-725 (1983)).

In porous fibrous thermal insulation materials, thermal transmission by radiation is an important factor (for example, Farnworth (1983), WU et al. (200&), Du et al. (2007)) affecting total heat flux. In order to reduce radiant heat flux, one possible method is to increase a fiber volume fraction (or reduce the porosity) (referring to Farnworth (1983) and Wu et al. (2007)) of the fibrous thermal insulation materials; or bring in high-density thin films to work as interlayers (Wu and Fan, Measurement of radiative thermal properties of thin polymer films by FTIR, Polymer Testing 27: 122-128 (2008)). However, these methods result in increased thermal conducting flux and reduced moisture permeability. When moisture vapor is transmitted in the fibrous thermal insulation materials (such as cold-proof clothing or sleeping bags), reduction of moisture permeability leads to accumulation and condensation of moisture vapor in the fibrous thermal insulation materials, which reduces thermal insulation effects. It is therefore a challenge to reduce the radiative heat loss without increasing conductive heat loss and blocking the moisture transmission.

Ultrafine fibers, metal fibers or metallized fibers are capable of reducing thermal transmission by radiation as a ratio of a surface area to a volume of the ultrafine fibers is relatively high, which increases absorption efficiency of thermal radiation, thereby enhancing blocking of thermal transmission by radiation. Plating a fiber surface with a metal reflection layer, is capable of increasing a radiation extinction coefficient, and further enhancing blocking of thermal radiation. Also, it is found that these materials have relatively high moisture permeability (Gibson et al., Transport properties of porous membranes based on electrospun nanofibers, Colloids and Surfaces A: Physicochemical and Engineering Aspects, 187-188, 469-481 (2001)). However, ultrafine fibers have a potential problem of relatively poor strength when they are used alone.

Generally, thermal radiation reflective materials are relatively heavy. Therefore, if these conventional thermal radiation reflective materials are used as interlayers or substrate layers of thermal insulation systems, weight increases unnecessarily and substantially. Substantial weight gain is undesirable for most cold-proof systems, especially for clothing, sleeping bags, and aircraft shells. Also, relatively thick coatings made of metals also greatly reduce water vapor permeability. When these materials are used in cold-proof clothing under extreme cold environments, water vapor condenses, resulting in much greater heat loss.

### SUMMARY OF THE INVENTION

The present invention seeks to alleviate at least one of the problems described above.

In a first broad form, the present invention provides a thermal insulation structure, including:

at least one layer of fibrous web, and

an infrared radiation reflective coating formed on each layer of the fibrous webs;

wherein each layer of the fibrous webs is separated by a coarse fiber layer, and the coarse fiber layer has a fiber volume fraction of less than 1%, and a fiber diameter of 20-35 μm.

Preferably, the fibrous webs may include ultrafine fibrous webs made of synthetic polymers, or fibrous webs of textile fabrics made of wool, down, cotton, synthetic fibrous materials, or a combination thereof.

Preferably, the ultrafine fibrous webs may include a fiber diameter of 0.5-2 μm, a fiber volume fraction of about 10%, and a thickness of 100-200 μm. Also preferably, the ultrafine fibrous webs may include fibrous webs formed by a melt-blown technique.

Preferable, the infrared radiation reflective coating may include a coating made of aluminum or aluminum oxide. Typically, the infrared radiation reflective coating may include a thickness of around 100-100 nm. Also typically, the infrared radiation reflective coating is formed on said ultrafine fibrous webs or textile fabrics by physical vapor deposition, magnetron sputtering, arc plasma deposition, chemical vapor deposition and a sol-gel method.

Preferable, the coarse fiber layers may include fiber layers made of wool, down, cotton, synthetic fibrous materials, or a combination thereof.

In a second broad form, the present invention provides a thermal insulation system including a thermal insulation structure in accordance with the first broad form of the present invention. Typically, the thermal insulation system may be embodied as an item of clothing, a sleeping bag, a component of a thermal insulation system for use in a building, electric automobile, and/or aircraft shell.

Advantageously, by virtue of the present invention adopting at least two layers of fibrous webs formed by ultrafine fibrous webs or textile fabrics, forming an infrared radiation reflective coating on each layer of fibrous web, and separating each of the fibrous webs by a coarse fiber layer, the present invention maintains the strength of the entire thermal insulation structure, and blocks thermal radiation without obstructing moisture vapor transmission, thereby improving thermal insulation performance. Also, the present invention exhibits relatively light weight in comparison to other competing technologies.

In a third broad form, the present invention provides a thermal insulation structure including:

a fabric layer; and

a dual-layer infrared radiation reflective metal coating disposed on a surface of the fabric layer;

wherein the dual-layer infrared radiation reflective metal coating includes a first coating layer directly applied on to the surface of the fabric layer, and, a second coating layer applied on to the first coating layer.

Preferable, the first coating layer of the dual-layer infrared radiation reflective metal coating may include at least one of copper, gold, lead and zinc.

Preferable, the second coating layer of the dual-layer infrared radiation reflective metal coating may include at least one of aluminium, silver and tin.

Preferably, the dual-layer infrared radiation reflective metal coating may be disposed on opposing surfaces of the fabric layer.

Preferably, the present invention may include a plurality of fabric layers forming a multi-layer structure, each of the fabric layers including a dual-layer infrared radiation reflective metal coating disposed on at least one surface of each of the fabric layers. The plurality of fabric layers may include substantially similar widths or may have vary in width.

Typically, an outermost surface of an outermost fabric layer of the plurality of fabric layers stacked together may not have a dual-layer coating disposed thereon.

Preferably, the fabric layer may include at least one of a cotton and a synthetic-fibre material.

Typically, the fabric layer may include at least one of a knitted and a woven fabric structure.

Typically, the fabric layer may include at least one of a plain, a twill and a satin weave structure.

Preferably, the present invention may include a heat-generating fiber layer. Also preferably, the heat-generating fiber layer may be arranged between adjacent fabric layers.

Preferably, the heat-generating fiber layer may include at least one of a polyester, a viscose, a nylon, a cotton, and a wool fibrous material.

Preferably, the heat-generating fiber layer may be formed by at least one of a non-woven, a melt-blown and a knitting technique. Typically, the heat-generating fiber layer may include a phase change material (PCM) fibre.

Preferably, the present invention may include a thermally insulative fibrous layer arranged before an outermost fabric layer. Typically, the thermally insulative fibrous layer may be formed by at least one of a non-woven, a melt-blown and a knitting technique.

Typically, the first and second coating layers of the dual-layer infrared radiation reflective metal coating may be applied by at least one of chemical treatment, physical vapor deposition, sputtering, arc plasma deposition, chemical vapor deposition, and sol-gel method.

Preferably, the dual-layer infrared radiation reflective coating may include a thickness approximately within the range of 10-330 nm.

In a fourth broad form, the present invention provides a thermal insulation system including the thermal insulation structure in accordance with the third broad form of the present invention.

Typically, the thermal insulation system may include at least one of an item of cold-proof clothing, a sleeping bag, a thermal insulation system of a building, an electric automobile or an aircraft shell.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 shows a thermal insulation structure according to one embodiment of the present invention;

FIG. 2 shows an exemplary thermal insulation structure according to another embodiment of the utility model;

FIGS. 3(a) and 3(c) show SEM images of a comparison sample at different magnifications;

FIGS. 3(b) and 3(d) show SEM images of a coated ultrafine fibrous web at different magnifications;

FIG. 4 shows a Fourier transform infrared spectrum (FTIR) analysis graph of a comparison sample and a coated ultrafine fibrous web sample; and

FIGS. 5(a) and 5(b) are analysis graphs of heat resistance and moisture resistance of a comparison sample and a coated ultrafine fibrous web sample.

FIG. 6 shows a thermal insulation structure in accordance with a further embodiment of the present invention having three fabric layers each with a dual-layer infrared radiation reflective metal coatings disposed on one side of each fabric layer.

FIG. 7 shows a thermal insulation structure in accordance with a further embodiment of the present invention having three fabric layers each with a dual-layer infrared radiation reflective metal coatings disposed on both sides of each fabric layer except an outer-most fabric layer.

FIG. 8 shows a thermal insulation structure in accordance with a further embodiment of the present invention having two fabric layers each with a dual-layer infrared radiation reflective metal coating disposed on one side of each fabric layer and with both fabric layers being directly adjacent one another.

FIG. 9 shows a thermal insulation structure in accordance with a further embodiment of the present invention having two fabric layers with a dual-layer infrared radiation reflective metal coating disposed on both sides of one fabric layer and a dual-layer infrared radiation reflective metal coating disposed on only an innermost side of an outer most fabric layer, with the fabric layers being directly adjacent one another.

FIG. 10 shows a thermal insulation structure in accordance with a further embodiment of the present invention having five fabric layers with a dual-layer infrared radiation reflective metal coating disposed on one side of each fabric layer, heat-generating fibrous materials arranged between each fabric layer except the fourth and fifth fabric layers which have a thermal insulative fibrous materials disposed between them.

FIG. 11 shows a thermal insulation structure in accordance with a further embodiment of the present invention having five fabric layers with a dual-layer infrared radiation reflective metal coating disposed on both sides of each fabric layer except an outermost fabric layer, with heat-generating fibrous materials arranged between each fabric layer except the fourth and fifth fabric layers which have a thermal insulative fibrous material disposed between them.

FIG. 12 shows a thermal insulation structure in accordance with a further embodiment of the present invention having five fabric layers with a dual-layer infrared radiation reflective metal coating disposed on one side of each fabric layer and the fabric layers being arranged directly adjacent one another.

FIG. 13 shows a thermal insulation structure in accordance with a further embodiment of the present invention having five fabric layers with a dual-layer infrared radiation reflective metal coating disposed on both sides of each fabric layer except an outermost fabric layer, and the fabric layers being arranged directly adjacent one another.

FIGS. 14(a)-(c) show graphs of percentage of direct infrared reflection, percentage temperature rise, and percentage direct temperature transmission of comparison samples, respectively.

FIGS. 15(a)-(b) show graphs of percentage of thermal resistance and evaporative resistance respectively in respected of tested comparison sample in the form of a jacket.

### DETAILED DESCRIPTION OF THE PREFERRED EMBODIMENTS

Preferred embodiments of the present invention will now be described as follows with reference to the accompanying drawings.

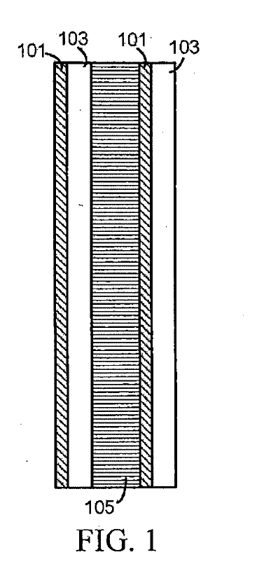

FIG. 1 shows a thermal insulation structure according to one embodiment of the present invention. The thermal insulation structure includes two layers of reflective ultrafine fibrous webs (101) and (103) separated by a fibrous batting layer made of coarse fibers. Each reflective ultrafine fibrous web includes an ultrafine fibrous web (103) and an infrared radiation reflective layer 101. The infrared radiation reflective layer (101) may be directly coated on the ultrafine fibrous webs or fibers.

To fabricate the reflective ultrafine fibrous web, a layer of ultrafine fibrous web is firstly prepared by application of a melt-blown technique could be applied t transform polymer resin into a molten mass, and the molten mass may then be squeezed out from a die head to form fibers. Generally, a high-speed airflow is adopted to blow the fibers until the fibers are separated from the die hole. Squeezed fibers are subsequently collected on a collection surface, and a nonwoven web is formed through self-adhesion behavior of fibers.

The ultrafine fibrous webs are made of ultrafine fibers of nano-scale or micron-scale. After the ultrafine fibrous webs are formed, as substrate, the ultrafine fibrous webs are coated with infrared radiation reflective materials.

The infrared radiation reflective layer (101) contain metals (such as aluminum (Al), argentum (Ag), and aurum (Au)), metal oxides (such as aluminum oxide (Al2O3), titanium dioxide (TiO2), zinc oxide (ZnO), and cerium dioxide (CeO2)), or metal oxides mixed with dopants (The dopants can be any of the following substances: fluorine, boron, aluminum, gallium, thallium, copper, and ferrum). The infrared radiation reflective materials may also be coated on the substrate by at least one of physical vapor deposition, magnetron sputtering, arc plasma deposition, chemical vapor deposition, and use of a sol-gel method.

In another embodiment, the ultrafine fibrous webs are replaced with textile fabric layers. The textile fabrics could for instance include wool, down, cotton, or synthetic fibrous materials. As a result, the infrared radiation reflective layer is coated on said textile fabrics.

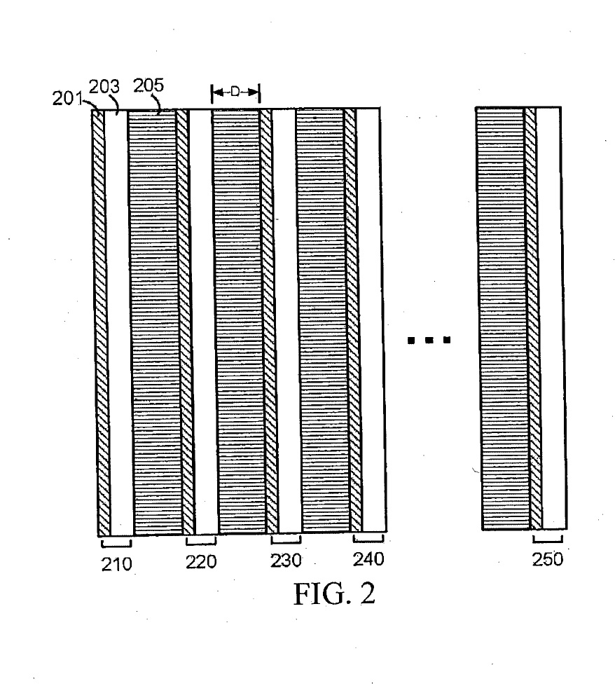

FIG. 2 shows an exemplary thermal insulation structure according to another embodiment of the present invention. In this embodiment, multiple reflective ultrafine fibrous webs (210, 220, 230, 240, and 250) are stacked together. Each layer is separated by a layer of fibrous batting (205) made of coarse fibers. Each layer of the reflective ultrafine fibrous web contains the ultrafine fibrous web (203) and infrared radiation reflective layer (201).

While the example of FIG. 2 shows a thermal insulation structure with five layers, an additional number of reflective ultrafine fibrous webs could be utilized depending on the specific application. For example, in cold environments, more reflective ultrafine fibrous webs may be used as interlayers. In a thermal insulation structure of cold-proof clothing and sleeping bags, one or multiple layers of reflective ultrafine fibrous webs or a layer of reflective ultrafine fibrous web may be added as interlayers. The coarse fiber layer (205) is a layer of high-porosity batting made of wool, polyester, or other synthetic fibrous materials.

An optimum distance (D) between two layers of reflective ultrafine fibrous webs depends on the volume fraction, a fiber diameter, and reflection characteristics of the reflective ultrafine fibrous webs, and the volume fraction and a fiber diameter of the coarse fiber layer (205), which may be obtained through experimental measurement and numerical simulation. Research work conducted by Hong Kong Polytechnic University has shown that the optimum distance between two layers of reflective ultrafine fibrous webs is 4-8 mm. A coarse fiber layer of 4-6 mm generally weights 20-100 grams per square meter.

Hence, these thermal insulation structures can be used under extreme cold climates so as to increase heat resistance to radiation without unacceptable increase in weight and reduction in water vapor permeability. These thermal insulation structures can be used for thermal insulation in items such as cold-proof clothing or sleeping bags. In addition, these thermal insulation structures can be used in building thermal insulation, automobile thermal insulation, and air aviation applications.

In the foregoing embodiment, the ultrafine fibrous webs generally have a fiber diameter of 0.5-2 μm, a fiber volume fraction of about 10%, and a thickness of about 100-200 μm depending on specific applications. A percentage of infrared radiation reflection at specific application temperature, and weight gain of coated thermal insulation materials can be controlled using the thickness of the infrared radiation reflective layers. Generally, a thickness of 10-100 nm can effectively reflect infrared radiation without substantially increasing weight. The thickness of an infrared radiation reflective coating is best from 20 nm to 40 nm.

In the foregoing embodiment, the coarse fiber layers generally have a fiber diameter of 20-35 μm, a fiber volume fraction of about 1%, generally a little less than 1%, and a thickness of about 5 mm.

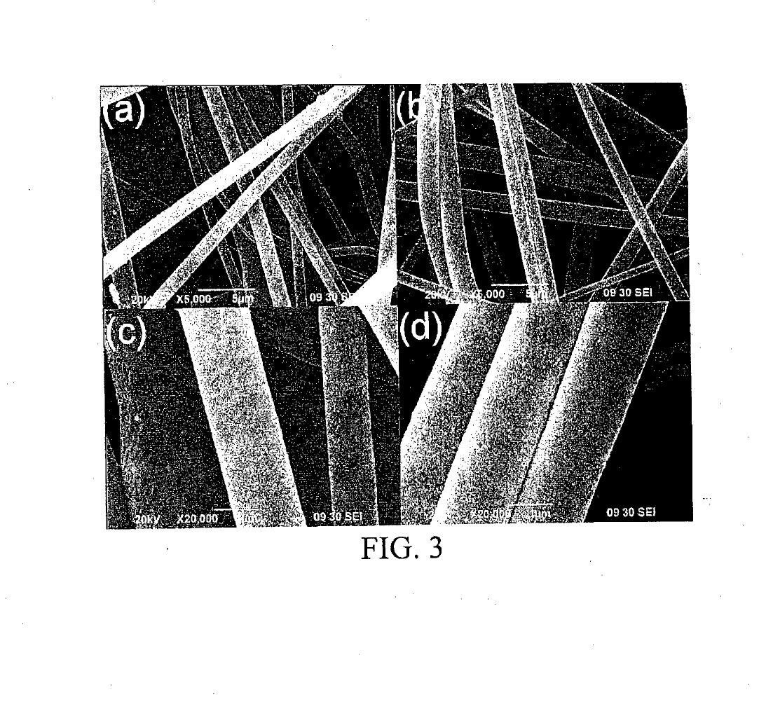

FIGS. 3(a)-3(d) illustrate scanning electron microscope (SEM) images of a comparison sample and a coated nonwoven sample. The comparison sample refers to an ultrafine fibrous web before infrared radiation reflective materials are coated, and the coated nonwoven sample refers to a reflective ultrafine fibrous web. FIGS. 3(a) and 3(c) are SEM images of a comparison sample at different magnifications; FIGS. 3(b) and 3(d) are SEM images of a coated ultrafine fibrous web sample at different magnifications. FIG. 3(d) shows granules, which are infrared radiation reflective materials (such as metals). These SEM images indicate that, the infrared radiation reflective coatings do not affect the fiber structure of the ultrafine fibrous webs. The infrared radiation reflective materials only need to be coated on the surfaces of ultrafine fibers.

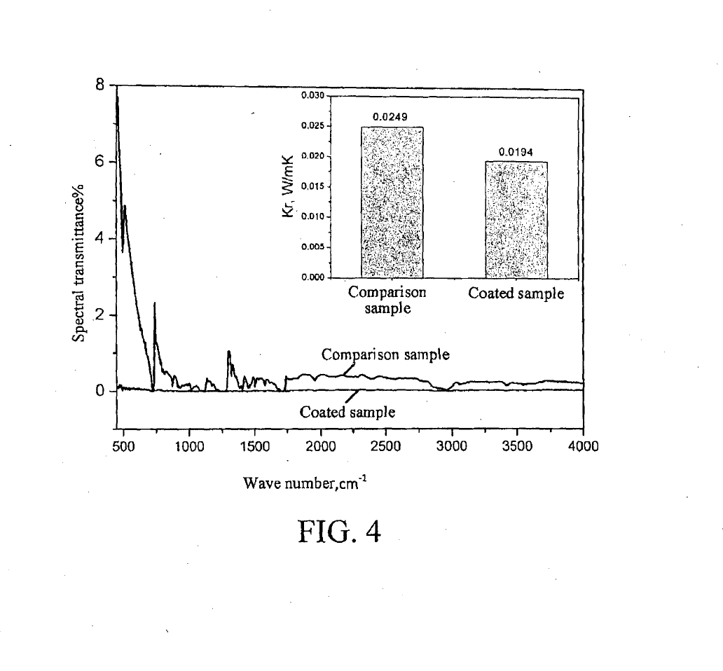

FIG. 4 is Fourier transform infrared spectrum (FTIR) analysis graph of a comparison sample and a coated ultrafine fibrous web sample. It can be seen from the infrared spectrum that, spectral transmittance of a coated sample is almost zero. The coated sample has a fiber thickness of 0.22 mm, while the uncoated sample has a fiber thickness of 0.16 mm.

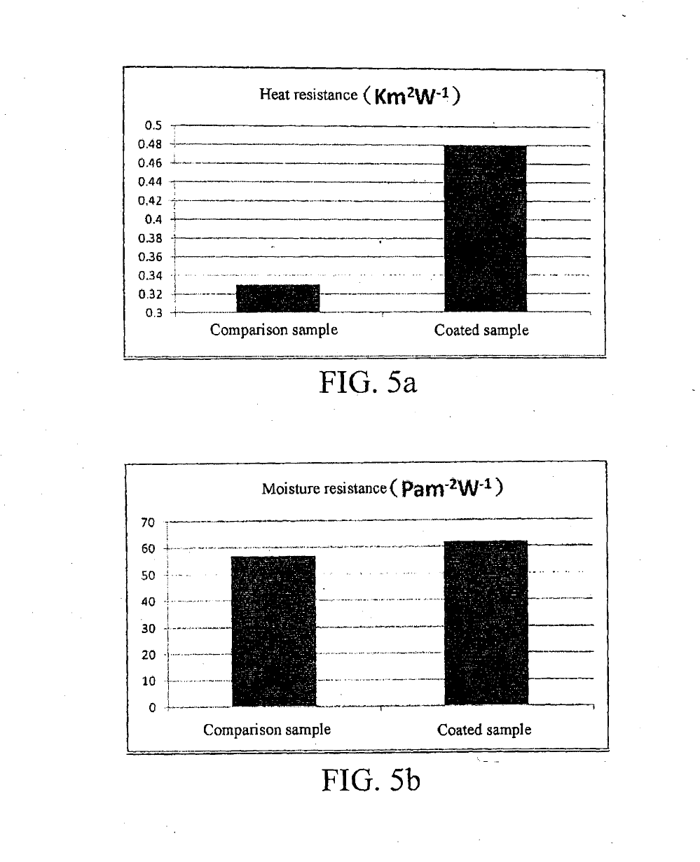

FIGS. 5(a) and 5(b) show test results of embodiments taken using a sweating guarded hot plate. FIG. 5(a) shows heat resistance comparing a thermal insulation structure formed by six layers of 5 mm batting separated by five layers of coated ultrafine fibrous webs with a thermal insulation structure formed by only six layers of 5 mm batting. FIG. 5(b) shows moisture resistance comparing a thermal insulation structure formed by six layers of 5 mm batting separated by five layers of coated ultrafine fibrous webs with a thermal insulation structure formed by only six layers of 5 mm batting. It can be seen that, application of the present technique is capable of increasing heat resistance by 45.5% with moisture resistance increasing only by 5%.

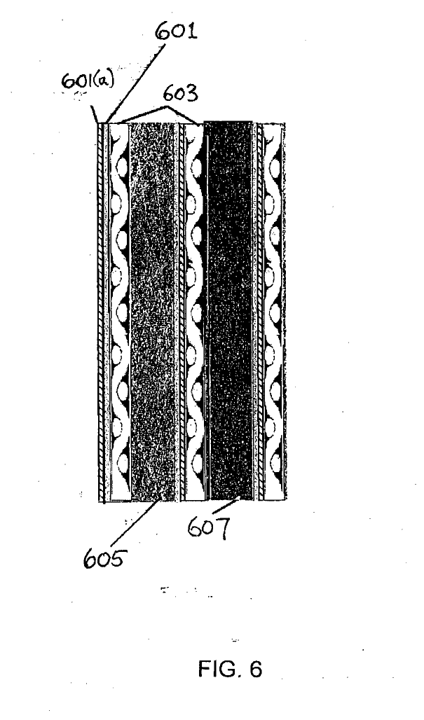

FIG. 6 shows a thermal insulation structure according to a further embodiment of the present invention. The thermal insulation structure includes three infrared reflective fabric layers (601, 601(a)/603) separated by a layer of fibrous material (605) made of heat generating PCM fibers and an insulating material (607). Each of the infrared reflective fabric layers includes a fabric (603) and an infrared reflective dual-layer coating (601,601(a)).

To form the infrared reflective dual-layer fabric, the fabric (603) is firstly prepared by weaving or knitting using various types of natural or synthetic yarns. The fabric (603) is then directly coated with infrared radiation reflective dual-layer materials (601,601(a)) which in this and the further-described embodiments includes a metal copper (Cu) layer (601) and an aluminum (Al) layer (601(a)). The copper layer (601) is first applied directly on to the surface of the fabric (603) and then the aluminium layer (601(a)) is then applied onto the copper layer (601).

The infrared reflective layers (601,601(a)) may be coated on to the fabric (603) by chemical treatment, physical vapor deposition, sputtering, arc plasma deposition, chemical vapor deposition, or sol-gel method.

The choice of copper (601) and aluminium (601(a)) coating layers in the dual-layer coating has been found to provide relatively good thermal reflection properties and relatively low thermal transmission properties. The copper absorbs the heat and because of the low specific heat, the temperature increases faster. The aluminum coating assists in providing a mirror like reflective surface on the fabric, which protects the heat like a thermoflax. It is possible to use other combinations of materials in the dual-layer coating of the fabric (603). In particular, metals having very low specific heat and good thermal reflection properties could be substituted for copper and aluminium. For instance, and by way of non-limiting example only, other dual-layer coating combinations may include:
A gold coating directly applied onto the fabric with a silver coating applied on to the gold coating
A gold coating directly applied onto the fabric with an aluminium coating applied on to the gold coating
A copper coating directly applied onto the fabric with a silver cotiing applied on to the copper coating;
A copper coating directly applied onto the fabric with a silver coating applied on to the copper coating
A copper coating directly applied onto the fabric with a tin coating applied on to the copper coating
A gold coating directly applied onto the fabric with a tin coating applied on to the gold coating
A lead coating directly applied onto the fabric with a tin coating applied on to the lead coating
A zinc coating directly applied onto the fabric with a aluminium coating applied on to the zinc coating
A zinc coating directly applied onto the fabric with a tin coating applied on to the zinc coating

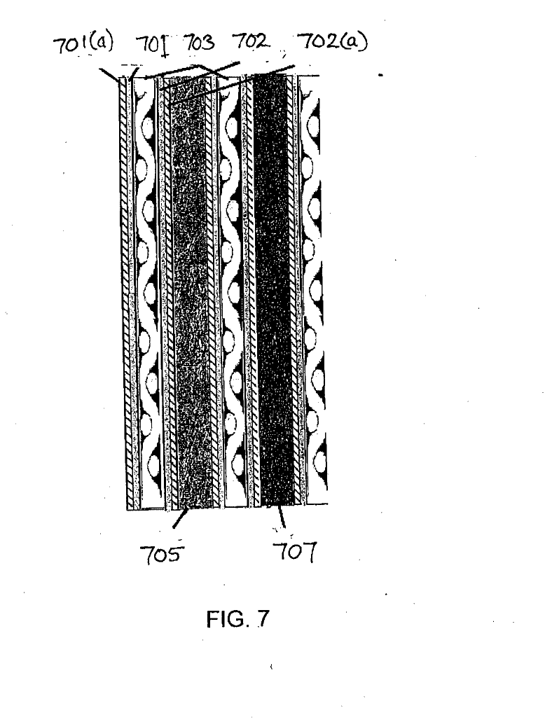

FIG. 7 shows an exemplary thermal insulation structure according to another embodiment of the present invention. In this embodiment, the thermal insulation structure includes dual-layer coating (701,701(a) and 702,702(a)) at both sides of each fabric layer (703) except on the outer-side of the outermost (i.e. right most) fabric layer. The thermal insulation structure includes a layer of fibrous material (705) made of heat generating PCM fibers and an insulation material (707). Copper layers (701 and 702) are directly coated on each side of the fabric layers (703) and layers of aluminium (701(a) and 702(a)) are coated on to the copper layers (701 and 702) respectively.

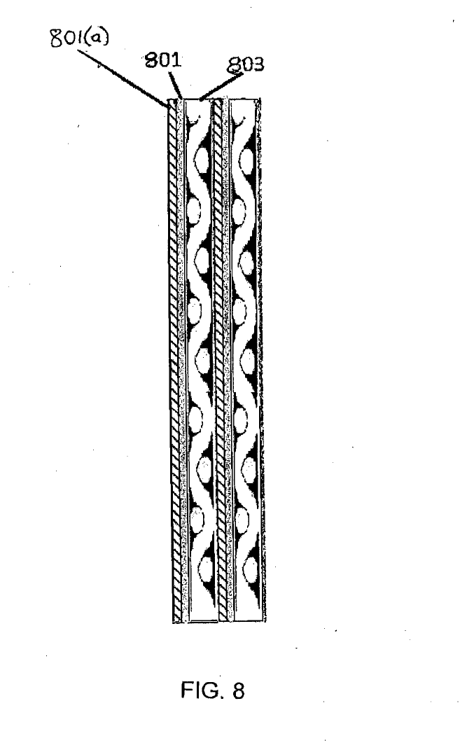

FIG. 8 shows an exemplary thermal insulation structure according to another embodiment of the present invention. In this embodiment, the thermal insulation structure includes two layers of fabric (803) having dual-coatings (801, 801(a)) on one side of each fabric layer (803).

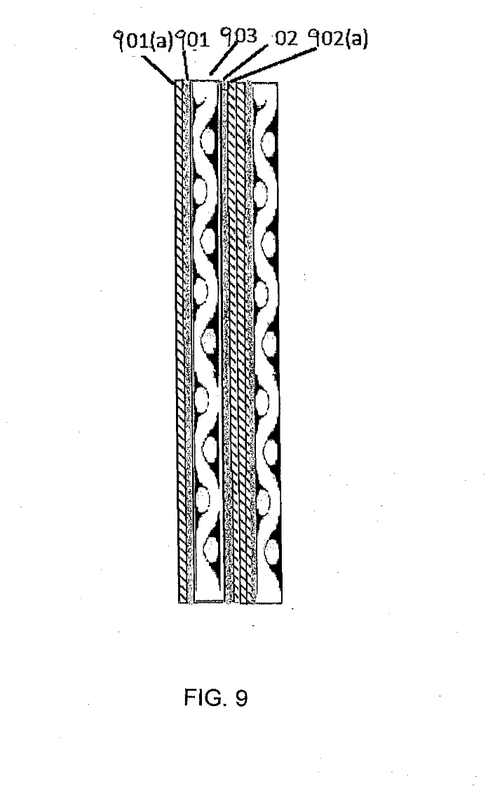

FIG. 9 shows an exemplary thermal insulation structure according to another embodiment of the present invention. In this embodiment, the thermal insulation structure includes two layers of fabric (903) with infrared reflective dual-coating layers (901,901(a) and 902,902(a)) on opposing sides of each fabric layer (903) except for the outermost (i.e. right-most) fabric layer. The coatings (901 and 902) include a copper material applied directly on to each side of each fabric layer (903) and coatings (901(a) and 902(a)) applied on to each of the copper coatings (901 and 902) respectively.

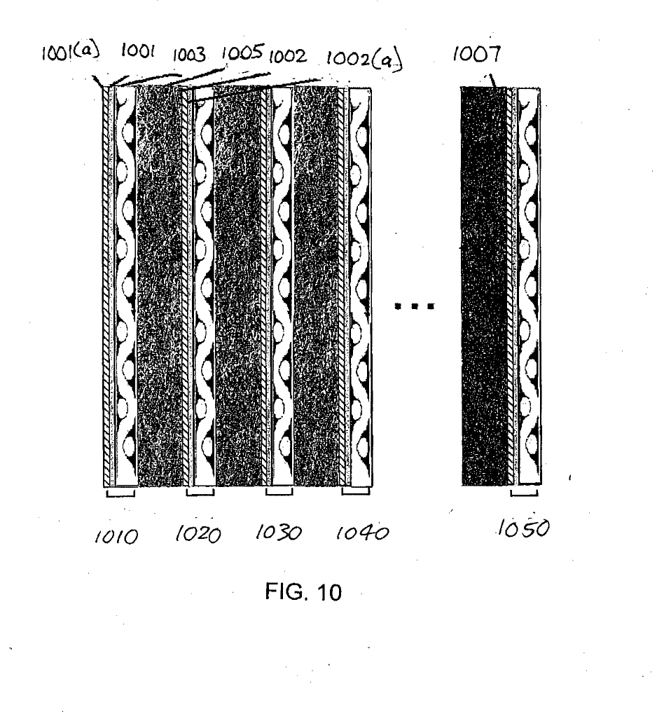

FIG. 10 shows an exemplary thermal insulation structure according to another embodiment of the present invention. In this embodiment, multiple fabric layers (1003) with infrared reflective dual-layer coatings (1001,1001(a) and 1002,1002(a) etc.) disposed on one side of each fabric layer (1003) are stacked together and form dual-layer coated infrared reflective fabric layers (1010, 1020, 1030, 1040 and 1050) whereby each (1010, 1020, 1030, 1040 and 1050) layer is separated by a layer of heat generating fibrous materials (1005). The coating layers (1001) and (1002) are copper layers directly applied on to the sides of the fabrics (1003) whilst layers 1001(a) and 1002(a) are aluminium layers applied on to the copper layers (1001) and (1002). A thermal insulative fibrous material (1007) is given before the outermost reflective coated fabric (1050) for retaining the heat inside the garment. While the example of FIG. 10 illustrates a thermal insulation structure with five layers, additional or fewer numbers of infrared reflective dual-layer coated fabrics may be utilized depending upon the specific applications.

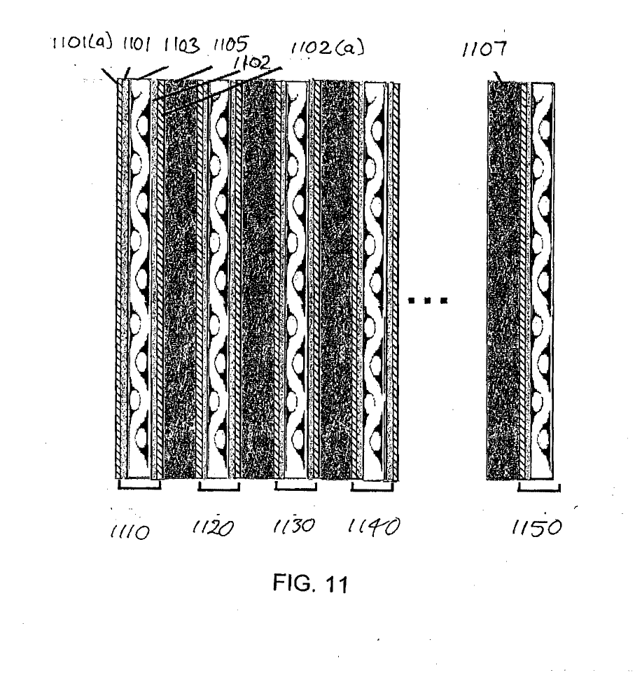

FIG. 11 shows an exemplary thermal insulation structure according to another embodiment of the present invention. In this embodiment, multiple infrared reflective dual-layer coated fabrics (1110, 1120, 1130, 1140 and 1150) are stacked together in the thermal insulation structure. Each layer (1110, 1120, 1130, 1140 and 1150) includes a fabric layer (1103) having a first dual-layer coating (1101, 1101(a)) applied on one side and a second dual-layer coating (1102, 1102(a)) applied on the opposing side of each layer (1110, 1120, 1130, 1140 and 1150). In each dual-coating a copper layer may be first directly applied on to the fabrics (1103) whilst an aluminium layer is applied on top of the copper layers. The layers (1110, 1120, 1130, 1140 and 1150) are separated by layers of heat generating fibrous materials (1105). A thermal insulative fibrous material (1107) is positioned before the outermost infrared reflective dual-coated fabric layer (1150) for retaining the heat inside, for instance a garment, made from the thermal insulation structure. While the example of FIG. 11 illustrates a thermal insulation structure with five layers, additional or fewer numbers of infrared reflective dual-layer coated fabrics may be utilized depending on specific applications.

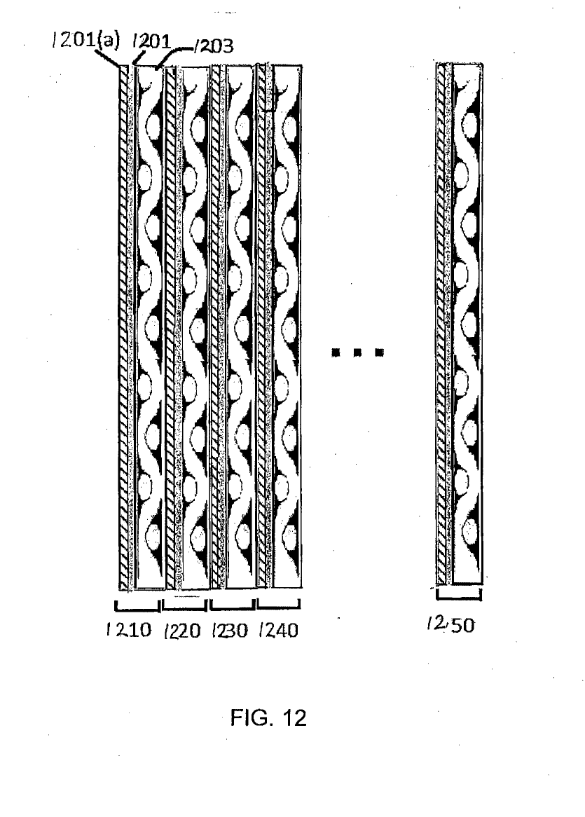

FIG. 12 shows an exemplary thermal insulation structure according to another embodiment of the present invention. In this embodiment, multiple infrared reflective dual-layer coated fabrics (1210, 1220, 1230, 1240 and 1250) are stacked together without any fibrous layers separating each layer (1210, 1220, 1230, 1240 and 1250). Each of the layers (1210, 1220, 1230, 1240 and 1250) are coated with the infrared reflective dual-layer coating (1201, 1201(a) etc.) one the innermost side (e.g. the left hand side of each layer) in FIG. 12. A copper layer (1201) is directly applied on to the side of each fabric (1203) with aluminium layers (1201(a)) applied on to the copper layers (1201). While the example embodiment depicted in FIG. 12 illustrates a thermal insulation structure with five layers, additional or fewer numbers of reflective fabrics layers may be utilized depending on specific applications.

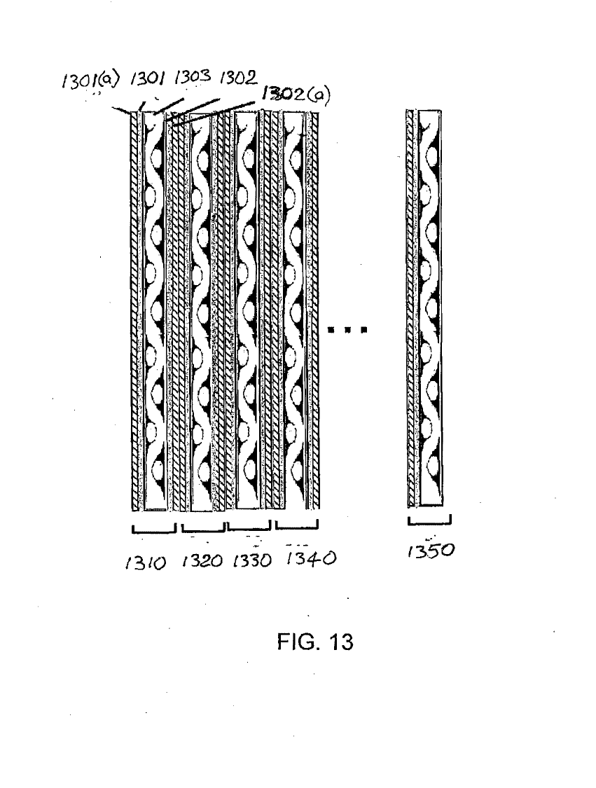

FIG. 13 shows an exemplary thermal insulation structure according to another embodiment of the present invention. In this embodiment, multiple infrared reflective dual-layer coated fabrics (1310, 1320, 1330, 1340 and 1350) are stacked together in the thermal insulation structure without any fibrous layers. Each of the infrared reflective dual-layer coated fabrics (1310, 1320, 1330, 1340 and 1350) includes a fabric (1303) coated with a first dual-layer coating (1301, 1301(a)) one side and a second dual-layer coating (1302, 1302(a)) on the other side. The coatings (1301) and (1302) in this embodiment are chosen as copper layers directly applied on to the sides of the fabric layers (1310, 1320, 1330, 1340 and 1350) with aluminium coatings (1301(a) and 1302(a)) applied on top of the copper layers (1301,1302). While the example of FIG. 13 illustrates a thermal insulation structure with five layers, additional or fewer numbers of infrared reflective fabrics may be utilized depending on specific applications.

The above-described thermal insulation structures in accordance with embodiments of the present invention can be used under extreme cold climates so as to increase heat resistance to radiation whilst alleviating increases in weight, and, reducing water vapor permeability damage. For different cold climatic situations, different combinations of structures (described with reference to FIGS. 6 to 13) may be used. Such combinations can be used for thermal insulation in items such as cold protective clothing or sleeping bags. Alternatively, these thermal insulation structures can be used in other applications such as in building insulation structure, shells of aircraft and so on.

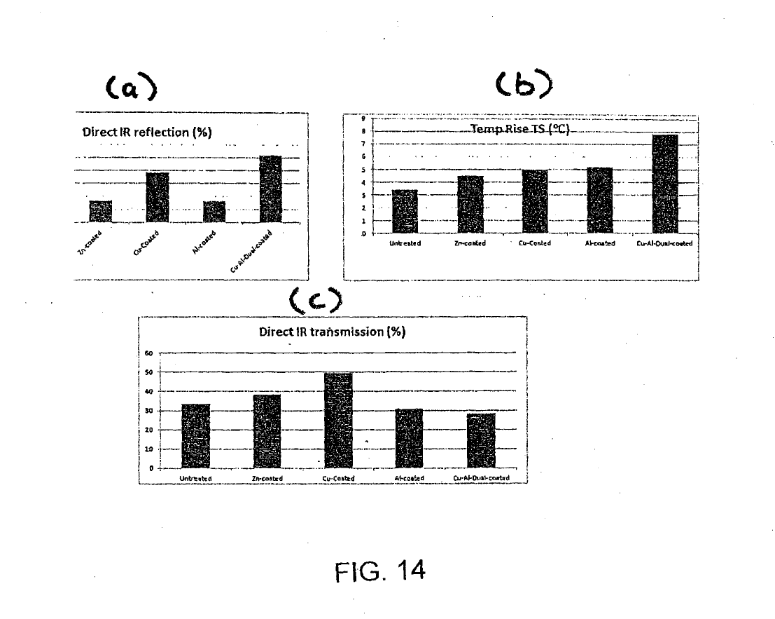

FIGS. 14(a)-(c) illustrate the results of testing of infrared reflection, transmission and temperature of sample embodiments. The result FIG. 14(a) clearly shows that the infrared reflection is superior using a dual-layer coating of copper-aluminum as compared to uncoated and other single-layer metal coated fabrics. The increase in infrared reflection for dual-layer coated fabrics causes a decrease in heat transmission as shown in FIG. 14(b) which is advantageous for instance in cold-protective clothing applications of embodiments where body heat retention is desirable. Increase in the fabric surface temperature FIG. 14(c) is the indication of that.

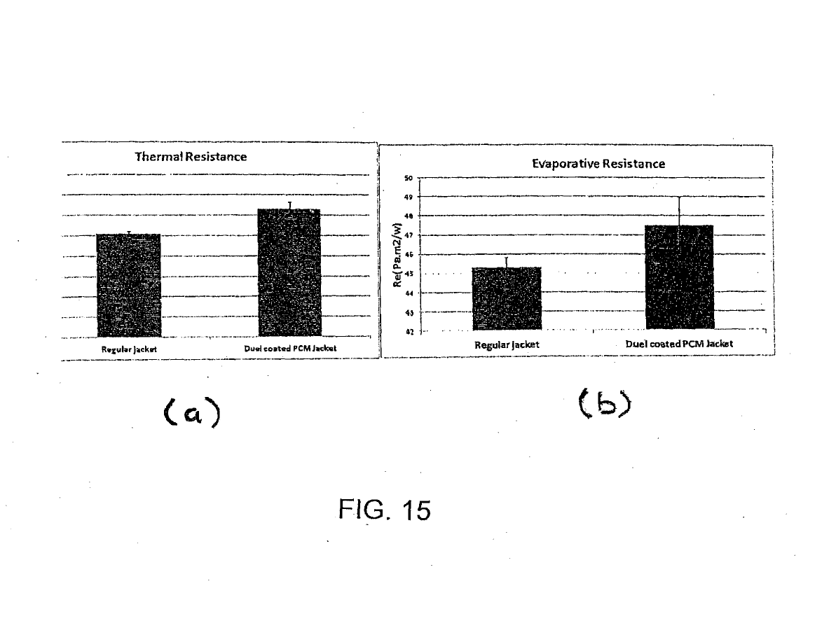

FIGS. 15(a) and 15(b) show test results of embodiments taken by using a “sweating manikin”. FIG. 15(a) shows that the difference is significant but in FIG. 15(b) there is different in average value, but it is not statistically significant.

Preferred embodiments of the present invention have been described above in detail, however a person skilled in the art should understand that without departing from the scope of the present invention, various changes and equivalent replacements can be made. In addition, to adapt to specific applications or materials of the present invention, many modifications can be made to the present invention without departing from the protection scope thereof. Therefore, the present invention is not limited to the specific embodiments disclosed herein, but should include all embodiments that fall within the protection scope of the present invention subject to the claims.

Those skilled in the art will appreciate that the present invention described herein is susceptible to variations and modifications other than those specifically described without departing from the scope of the present invention. All such variations and modifications which become apparent to persons skilled in the art, should be considered to fall within the spirit and scope of the present invention as broadly hereinbefore described. It is to be understood that the present invention includes all such variations and modifications. The present invention also includes all of the steps and features, referred or indicated in the specification, individually or collectively, and any and all combinations of any two or more of said steps or features.

The reference to any prior art in this specification is not, and should not be taken as, an acknowledgement or any form of suggestion that that prior art forms part of the common general knowledge.

1. A thermal insulation structure, including
at least one layer of fibrous web, and
an infrared radiation reflective coating formed on each layer of the fibrous webs;
wherein each layer of the fibrous webs is separated by a coarse fiber layer, and the coarse fiber layer has a fiber volume fraction of less than 1%, and a fiber diameter of 20-35 μm.

2. A thermal insulation structure as recited in claim 1, wherein the at least one fibrous web includes an ultrafine fibrous web made of synthetic polymer, or, a fibrous web of textile fabric made of at least one of wool, down, cotton, synthetic fibrous materials.

3. A thermal insulation structure as recited in claim 2, wherein the ultrafine fibrous web includes a fiber diameter of 0.5-2 μm, a fiber volume fraction of about 10%, and a thickness of 100-200 μm.

4. A thermal insulation structure as recited in claim 1, wherein the ultrafine fibrous web includes a fibrous web made by meltblown technique.

5. A thermal insulation structure as recited in claim 1, wherein the infrared radiation reflective coating includes a coating made of at least one of aluminum and aluminum oxide.

6. A thermal insulation structure as recited in claim 5, wherein the infrared radiation reflective coating includes a thickness approximately within the range of 10-100 nm.

7. A thermal insulation structure as recited in claim 2, wherein the infrared radiation reflective coating includes a coating formed on the ultrafine fibrous web or textile fabric by at least one of physical vapor deposition, magnetron sputtering, arc plasma deposition, chemical vapor deposition, and a sol-gel method.

8. A thermal insulation structure as recited in claim 1, wherein the coarse fiber layers includes fiber layers made of at least one of wool, down, cotton and a synthetic fibrous material.

9. A thermal insulation system including the thermal insulation structure of claim 1.

10. A thermal insulation system as recited in claim 9, wherein the thermal insulation structure forms a part of at least one of an item of cold-proof clothing, a sleeping bag, a thermal insulation system of a building, an electric automobile or an aircraft shell.

11. A thermal insulation structure including:
a fabric layer; and
a dual-layer infrared radiation reflective metal coating disposed on a surface of the fabric layer;
wherein the dual-layer infrared radiation reflective metal coating includes a first coating layer directly applied on to the surface of the fabric layer, and, a second coating layer applied on to the first coating layer.

12. A thermal insulation structure as recited in claim 11 wherein the first coating layer of the dual-layer infrared radiation reflective metal coating includes at least one of copper, gold, lead and zinc.

13. A thermal insulation structure as recited in claim 12 wherein the second coating layer of the dual-layer infrared radiation reflective metal coating includes at lest one of aluminium, silver and tin.

14. A thermal insulation structure as recited in claim 13 wherein the dual-layer infrared radiation reflective metal coating is disposed on opposing surfaces of the fabric layer.

15. A thermal insulation structure as recited in claim 14 including a plurality of fabric layers forming a multi-layer structure, each of the fabric layers including a dual-layer infrared radiation reflective metal coating disposed on at least one surface of each of the fabric layers.

16. A thermal insulation structure as recited in claim 15 wherein an outermost surface of an outermost fabric layer of the plurality of fabric layers stacked together does not have a dual-layer coating disposed thereon.

17. A thermal insulation structure as recited in claim 16 wherein the fabric layer includes at least one of a cotton and a synthetic-fibre material.

18. A thermal insulation structure as recited in claim 17 wherein the fabric layer includes at lest one of a knitted and a woven fabric structure.

19. A thermal insulation structure as recited in claim 18 wherein the fabric layer includes at lest one of a plain, a twill and a satin weave structure.

20. A thermal insulation structure as recited in claim 19 including a heat-generating fiber layer.

21. A thermal insulation structure as recited in claim 20 wherein the heat-generating fiber layer is arranged between adjacent fabric layers.

22. A thermal insulation structure as recited in claim 21 wherein the heat-generating fiber layer includes at least one of a polyester, a viscose, a nylon, a cotton, and a wool fibrous material.

23. A thermal insulation structure as recited in claim 22 wherein the heat-generating fiber layer is formed by at lest one of a non-woven, a melt-blown and a knitting technique.

24. A thermal insulation structure as recited in claim 23 wherein the heat-generating fiber layer includes a phase change material (PCM) fibre.

25. A thermal insulation structure as recited in claim 24 including a thermally insulative fibrous layer arranged before an outermost fabric layer.

26. A thermal insulation structure as recited in claim 25 wherein the thermally insulative fibrous layer is formed by at least one of a non-woven, a melt-blown and a knitting technique.

27. A thermal insulation structure as recited in claim 26 wherein the first and second coating layers of the dual-layer infrared radiation reflective metal coating are applied by at lest one of chemical treatment, physical vapor deposition, sputtering, arc plasma deposition, chemical vapor deposition, and sol-gel method.

28. A thermal insulation structure as recited in claim 27 wherein the dual-layer infrared radiation reflective coating includes thickness approximately within the range of 10-330 nm.

29. A thermal insulation system including the thermal insulation structure in accordance with claim 28.

30. A thermal insulation system as recited in claim 29 including at least one of an item of cold-proof clothing, a sleeping bag, a thermal insulation system of a building, an electric automobile or an aircraft shell.
